(19) United States
(12) Patent Application Publication
(10) Pub. No.: US 2008/0163079 A1
(43) Pub. Date: Jul. 3, 2008

(54) METHOD AND SYSTEM FOR SWITCHING VIEWS OF DATA DISPLAYED IN TABULAR FORMAT IN COMPUTER APPLICATIONS

(76) Inventor: Tobias Haug, Heidelberg (DE)

Correspondence Address: KENYON & KENYON LLP, 1500 K STREET N.W., WASHINGTON, DC, 20005, US

(21) Appl. No.: 11/617,374

(22) Filed: Dec. 28, 2006

(51) Int. Cl. G06F 3/00

(52) U.S. Cl. 715/762

(57) ABSTRACT

A method and a system are provided for switching the view of data displayed in tabular format in computer displays. According to some embodiments, a view switch tool is incorporated into a graphical design that minimizes view changing time and permits the user to maintain concentration on the data.

### FIELD OF THE INVENTION

The present invention relates to a system and method for changing the view of data displayed in tabular format.

### BACKGROUND

The present invention provides a view switching tool for use in computer applications through which operators may change views of information or data viewable in tabular format.

Graphical user interfaces are common in modern computing applications. They typically represent data as graphical objects that can be selected and modified by a computers pointing device.

Various applications permit users to select among views to display information or data viewable in tabular format. Calendars, for example, permit users to select a time range, such as a day or a month, and, in response thereto, display events contained within the selected time range. Various other implementations are possible.

In any of these instances, users require a convenient and efficient mechanism to select among various available views to display data in a manner appropriate to the users' needs. Current tools, by for example locating menus used to switch views in a main tool bar away from the data, do not provide a convenient and efficient mechanism for view selection that enable a user to comprehend that view selection relates to the data. Accordingly, there is a need in the art for an improved graphical user interface for browsing and selecting among views for displaying data viewable in tabular format in computer applications.

### BRIEF DESCRIPTION OF THE DRAWINGS

FIG. 1 illustrates an exemplary application window for a calendar application according to an embodiment of the present invention.

FIG. 2 illustrates a method according to an embodiment of the present invention.

FIG. 3 illustrates another exemplary application window for a calendar application according to an embodiment of the present invention.

FIG. 4 illustrates an exemplary application window permitting a user to define the data to be displayed.

FIG. 5 illustrates an exemplary application window for university schedule viewing.

FIG. 6 illustrates a simplified diagram of a computer network suitable for use with various embodiments of the present invention.

### DETAILED DESCRIPTION

Embodiments of the present invention provide a view selection tool for switching the view of data viewable in tabular format for an application user interface. The view selection tool includes a plurality of selectable views and is located substantially within the boundaries of a data pane displaying data. User commands may be entered via the view selection tool to select the desired view from the presented views. As such, the view selection tool provides an efficient and convenient user tool for view selection of information or data contained in a table.

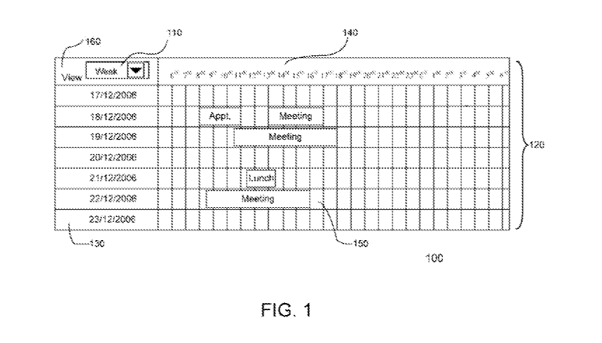

FIG. 1 illustrates an exemplary application window for a calendar application 100 according to an embodiment of the present invention. The application window includes a view selection tool 110 and a data pane 120. A view selection tool permits a user to select, from a plurality of views, a view in which data may be displayed. A data pane may comprise a display area of data viewed in tabular format in the user interface. As illustrated in FIG. 1, the view selection tool 110 in this exemplary embodiment is located substantially within the boundaries of the data pane 120. During design of the graphical user interface, the designer may locate the view selection tool within the data pane instead of or in addition to locating the view selection tool, for example, on the main tool bar.

Typically, the application may display temporal data in the data pane 120. In the example of FIG. 1, the data consists of temporal data. The data pane 120 displays each day of a calendar week on the vertical axis 130 and the hours in a day on the horizontal axis 140. The view selection tool 110 may include time ranges among the plurality of selectable views. In this example, the time range of a week is displayed as the selected view in the view selection tool 110. Other time ranges may include, for example, a day, a month, or a year. The specific time range displayed, the week of December 17-23 in this example, may be selected by a user via a drop-down tool or other graphical interface. As illustrated in FIG. 1, the data pane may also display other data 150, such as appointments or meetings occurring during the displayed week, previously entered by the user via a graphical interface.

Typically, the application may display the view selection tool in a first cell of a displayed table. The first cell of the table is located where the first row and first column of the table intersect. In this embodiment, the view selection tool 110 is located in the first cell 160, where vertical axis 130, the first column, and the horizontal axis 140, the first row, intersect.

The view selection tool 110 may be integrated for use within a variety of applications, such as personal information managers that manage appointments for individual users. The view selection tool 110 may also be integrated for use within other non-temporal applications, such as a university schedule viewing application that displays enrollment information for various schools and classes. The view selection tool 110 may be integrated into any application that displays relational or hierarchical data in tabular format that requires an operator to select a view as an input to the application.

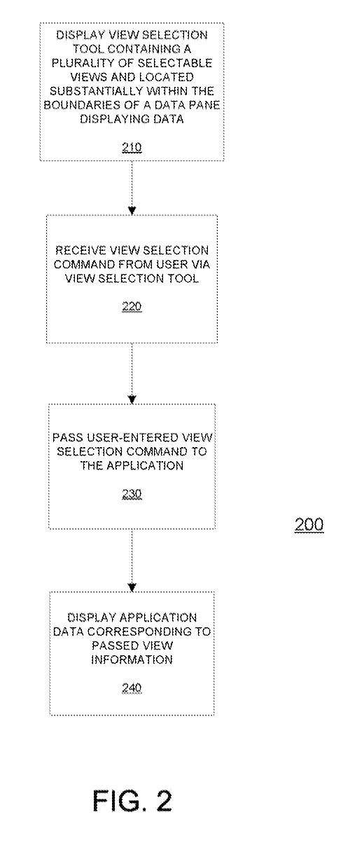

FIG. 2 illustrates a method 200 according to an embodiment of the present invention. The method may be invoked in response to an event entered with respect to the application, resulting from user input. The method 200 may display a view selection tool substantially within the boundaries of the data pane and the view selection tool in the method may contain a plurality of user-selectable views 210. In response to a user selection command entered by the user via the view selection tool 220, for example by clicking a selectable view from a drop-down menu using the computers pointing device, the method may pass view information to the application based on the user-entered view selection command 230. The method may also display application data corresponding to the passed view information 240. For example, by clicking on year from a drop-down menu view selection tool, the operator may view calendar data for a year, Similarly, by clicking on a month from a drop-down menu view selection, the operator may view calendar data for a month.

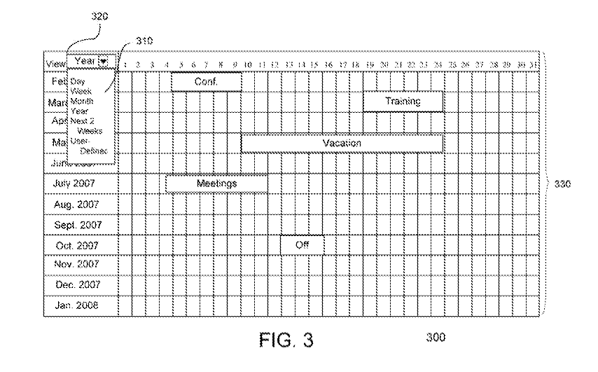

FIG. 3 illustrates an exemplary application window for a calendar application 300 that includes a plurality of selectable views 310 displayed after a user has activated the view selection tool drop-down menu 320 by clicking on the drop-down menu 320. The displayed plurality of selectable views 310 may be an input system to accept user input representing a selection from the plurality of selectable views. The user inputs a selection from the plurality of selectable views 310 by pointing to and clicking on the desired view. Pointing and clicking on the desired view may display data, corresponding to the selection, in the data pane 330. In this exemplary embodiment, the plurality of selectable views 310 in the view selection tool 320 include time ranges, such as day, week, month, year, and next 2 weeks. The embodiment illustrated in FIG. 3 includes, as a selectable view in the plurality of views 310, a user-defined view. The user may select the user-defined view to display data based on parameters entered by the user.

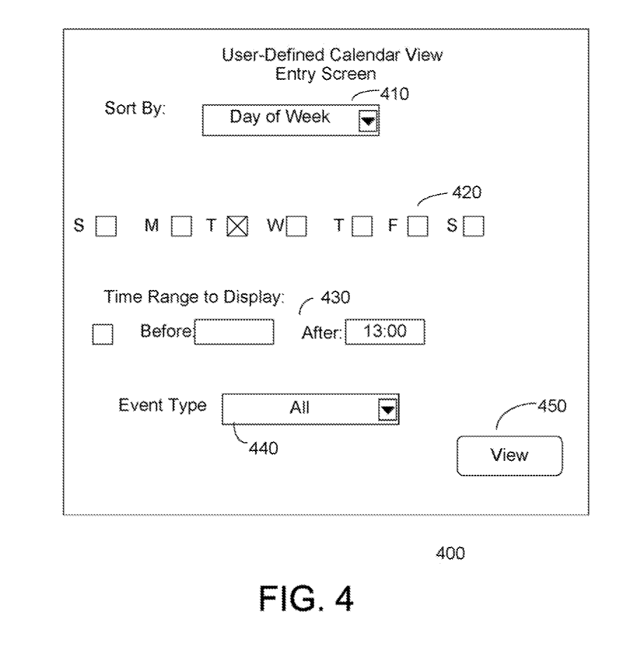

FIG. 4 illustrates an exemplary application window permitting a user to define the data to be displayed 400. The user-defined view entry window 400 may be presented if the user selects the user-defined view from the plurality of views 310 available in the view selection tool 310. In the example of FIG. 4, the user may select from a drop-down menu 410 a primary sorting parameter. Sorting by day of the week 410 is illustrated in this example. Further examples of primary sorting parameters include, but are not limited to, event type, day of month, and week of month. After the user selects day of week in this example, the user may further limit the data to display. The additional user-defined parameters may include: the days to be displayed 420, selectable by clicking the pointing device in the box next to a day—T for Tuesday is selected in this example; the hour range of the selected days 430, selectable by clicking the pointing device in the box next to “All” for the entire day or limiting the hours by entering times in the “Before” box or “After” box—after 13.00 is entered in this example; the event types, selectable from a drop-down menu 440—in this example all event types is selected. Additional embodiments may include other user-defined parameters. Upon selecting the desired parameters for viewing, the user may select the “View” button 450 to pass the user-defined information to the application.

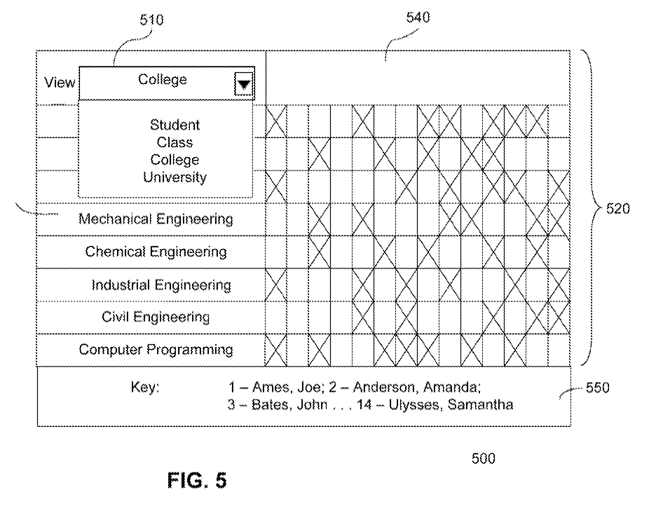

FIG. 5 illustrates an exemplary application window for a university schedule viewing application 500. The application window includes a view selection tool 510 and a data pane 520. As illustrated in FIG. 5, the view selection toot 510 in this exemplary embodiment is located substantially within the boundaries of the data pane 520.

In this embodiment, the view selection tool 510 is a drop-down menu of user-selectable views in the example of FIG. 5, the classes offered by the engineering school at a university are displayed by the application in the data pane 520. The view selection tool 510 is shown as displaying a “College” view. The College view in this example displays on the vertical axis 530 each class offered in the engineering school and displays on the horizontal axis 540 the engineering students, listed by number. In this embodiment, the students' names are displayed in a key 550 beneath the data pane 520. The specific college for which classes are displayed, the engineering school in this example, may be selected by a user via a drop-down tool or other graphical interface. As illustrated in FIG. 5, the data pane may also display other data, such as indications of the classes in which particular students are enrolled by an “X” in the appropriate cells, previously entered by the user via a graphical interface.

This embodiment contemplates other views in addition to the view illustrated in FIG. 5. For example, if the user selects university from the drop-down menu view selection tool, the application may display, for example, the individual colleges of the university on the vertical axis 530 and all of the classes offered at the university on the horizontal axis 540. Other data displayed in such a view might include an “X” in appropriate cells indicating which college offers a particular class.

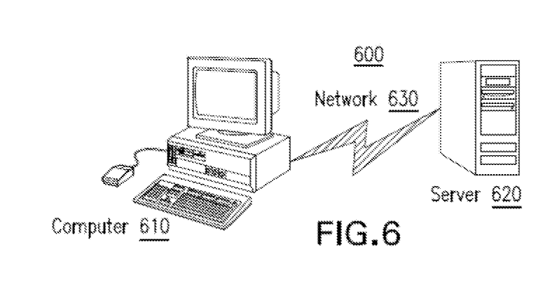

FIG. 6 is a simplified block diagram of a computer network 600 suitable for use with the present invention. The network may include one or more computers 610 and network servers 620 interconnected via a network fabric 630. The computers 610 may include processors, memory devices and input/output devices and may execute various program instructions that manage their operation. Some program instructions may define an operating system for the computer, while other program instructions may define various applications such as personal information managers, word processors, spreadsheet applications, browsers and enterprise resource management applications, among others. The view selection tool of the present invention may find use in various applications in which data is displayed in tabular format. As such, the view selection tool may be represented by program instructions that are stored in the computer's memory system.

Computers 610 may be integrated into a larger network and provided in communication with servers 620. In such instances, the servers 620 may execute applications and present data to the computers 610 as part of their operations. In one embodiment, the computer and server may communicate via portal-based communication sessions. In this operation, the view selection tool may be presented to a computer via a browser based interface. As such, the view selection tool may be represented by program instructions that are stored in the server's memory system.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

What is claimed is:

1. A user interface tool for changing the view of data viewable in tabular format in an application, comprising:
displaying a view selection toot in an application user interface, the view selection tool including a plurality of selectable views and the view selection tool located substantially within the boundaries of a data pane displaying data; and
responsive to a user selection command entered via the view selection tool, passing view information represented by the selection command to the application.

2. The method of claim 1, wherein the data is temporal data.

3. The method of claim 2, wherein the plurality of selectable views includes time ranges.

4. The method of claim 1, wherein the view selection tool is located in the application user interface in a first cell of a displayed table, the first cell located where the first row and first column of the table intersect.

5. The method of claim 4, wherein the data is temporal data.

6. The method of claim 5, wherein the plurality of selectable views includes time ranges.

7. The method of claim 1, wherein the plurality of selectable views includes a user-defined view and the selection command further comprises permitting a user to define the information passed.

8. The method of claim 7, wherein the data is temporal data.

9. The method of claim 8, wherein the plurality of selectable views includes time ranges.

10. The method of claim 1, further comprising displaying application data corresponding to the passed view information.

11. A view selection tool provided within a computer user interface, comprising:
a plurality of selectable views located substantially within the boundaries of a data pane displaying data in an application user interface;
an input system located substantially within the boundaries of the data pane to accept user input representing a selection from the plurality of selectable views; and
a display of the data, corresponding to the selection, in the data pane.

12. The tool of claim 11, wherein the data is temporal data.

13. The tool of claim 12, wherein the plurality of selectable views includes time ranges.

14. The tool of claim 11, wherein the view selection tool is located in the application user interface in a first cell of a displayed table, the first cell located where the first row and first column of the table intersect.

15. The tool of claim 14, wherein the data is temporal data.

16. The tool of claim 15, wherein the plurality of selectable views includes various time units.

17. The tool of claim 11, wherein the plurality of selectable views includes a user-defined view and the input system further comprises permitting a user to define the information passed.

18. The tool of claim 17, wherein the data is temporal information or data and the plurality of selectable views includes time ranges.

19. A computer readable medium having program instructions stored thereon that, when executed cause a device to:
display a view selection tool in an application user interface, the view selection tool including a plurality of selectable views and the tool located substantially within the boundaries of a data pane displaying data; and
responsive to a user selection command entered via the view selection tool, pass view information represented by the selection command to the application.
